(19) United States
(12) Patent Application Publication
(10) Pub. No.: US 2006/0182989 A1
(43) Pub. Date: Aug. 17, 2006

(54) Thin cast strip with protective layer, and method for making the same

(75) Inventors: Walter N. Blejde, Brownsurg, IN (US); Rama Ballav Mahapatra, Brighton-Le-Sands (AU)

Correspondence Address: HAHN LOESER & PARKS, LLP, One GOJO Plaza, Suite 300, AKRON, OH, 44311-1076, US

(73) Assignee: NUCOR CORPORATION

(21) Appl. No.: 11/059,137

(22) Filed: Feb. 15, 2005

(51) Int. Cl. C03C 27/02

(52) U.S. Cl. 428/632; 428/640

(57) ABSTRACT

A steel strip made with protective layer of less than 100 nanometers with Fe₂0₃ adjacent the base metal of the strip. The steel strip may be made by assembling two casting rolls in lateral relationship to form a nip there between through which strip can be cast, forming a casting pool supported on the casting rolls above the nip at a temperature such that the temperature of the steel is greater than about 1,300° C. at the nip between the casting rolls, counter-rotating the casting rolls such that the peripheral surfaces of the casting rolls each travel toward the nip to produce a cast strip downwardly from the nip, and passing the continuous cast strip through at least one cooling chamber that has less than 5% oxygen to cool the strip to less than 150° C. or until coiled without disrupting the surface of the strip adjacent the protective layer formed.

### BACKGROUND AND SUMMARY OF THE INVENTION

This invention relates to steelmaking and particularly making of a unique thin steel strip by continuous casting in a roll caster.

One of the difficult problems in making low carbon steel strip is the presence of scale formed as a surface layer by oxidization on exposure of the strip to ambient or another oxygen containing atmosphere. Production of such steel strip can be done by continuous casting of the steel strip in a twin roll caster, followed by hot rolling and coiling of the strip typically into 20 ton coils. During that processing, the surface of the strip is oxidized and scale is formed on the strip from processing at elevated temperatures in the presence of oxygen from the surrounding atmosphere. The scale (iron oxides) formed on the surface of the strip typically consists of a layer of wustite (FeO) formed next to the base steel, a magnetite layer (Fe₂O₄) over the wustite layer, and a hematite layer (Fe₂O₃) over the magnetite layer. See, e.g., K. Voges and A Gibson, New Cleaning Process for Hot Rolled Steel Prior to Galvanizing at FIG. 3. The scale produced, while generally not inhibiting coiling of the strip, presented a difficult problem and resulted in the need for expensive processing of the strip in later manufacturing stages and in fabrication of parts from the strip. Generally, the strip had to be pickled in acid to remove the scale, which presented an environment problem in disposal of the acid, and then the pickled steel strip had to be coated or painted, all at substantial expense. For example, the strip could be galvanized by coating with zinc, aluminized by coating with aluminum, or coated with an alloy of zinc and aluminum to form a GALVUME® coating on the strip.

There has been, therefore a need for a way to form a protective layer on the steel strip during formation of the strip that would eliminate at least the step of later cleaning the strip by pickling or otherwise before further fabrication, and reduce if not eliminate the cost of later coating the strip in making products from the strip. We have found a surprising and unique way of making steel strip so as to create a novel cast steel strip with a protective layer formed in situ. This novel steel strip is made by continuous casting using a twin roll caster.

In a twin roll caster, molten metal is introduced between a pair of conter-rotated horizontal casting rolls which are internally cooled so that metal shells solidify on the moving roll surfaces and are brought together at the nip between them to produce a thin cast strip product, delivered downwardly from the nip between the casting rolls. The term “nip” is used herein to refer to the general region at which the casting rolls are closest together. The molten metal may be poured from a ladle through a metal delivery system comprised of a tundish and a core nozzle located above the nip, to form a casting pool of molten metal supported on the casting surfaces of the rolls above the nip and extending along the length of the nip. This casting pool is usually confined between refractory side plates or dams held in sliding engagement with the end surfaces of the rolls so as to dam the two ends of the casting pool against outflow.

When casting steel strip in a twin roll caster, the thin cast strip leaves the nip at very high temperatures, of the order of 1400° C. If exposed to normal atmosphere, it will suffer very rapid scaling due to oxidation at such high temperatures. A sealed enclosure is therefore provided beneath the casting rolls to receive the hot cast strip, and through which the strip passes away from the strip caster, which contains an atmosphere that inhibits oxidation of the strip. The oxidation inhibiting atmosphere may be created by injecting a non-oxidizing gas, for example, an inert gas such as argon or nitrogen, or combustion exhaust reducing gases. Alternatively, the enclosure may be sealed against ingress of an ambient oxygen-containing atmosphere during operation of the strip caster, and the oxygen content of the atmosphere within the enclosure reduced, during an initial phase of casting, by allowing oxidation of the strip to extract oxygen from the sealed enclosure as disclosed in U.S. Pat. Nos. 5,762,126 and 5,960,855.

In the present invention, a method of producing thin cast strip with a protective layer is comprised of the steps of:

a) assembling a pair of casting rolls having a nip therebetween;

b) assembling a metal delivery system capable of delivering molten metal to form a casting pool between the casting rolls above the nip, and first side dams adjacent the ends of the nip to confine said casting pool;

c) introducing molten steel to form a casting pool supported on casting surfaces of the casting rolls and confined by said first side dams at a temperature such that the steel is above about 1300° C., e.g. 1300-1350° C. (2370-2460° F.) at the nip between the casting rolls;

d) counter-rotating the casting rolls to form solidified metal shells on the surfaces of the casting rolls and cast thin steel strip through the nip between the casting rolls from said solidified shells;

e) enclosing the thin cast strip in an atmosphere of less than 5% oxygen during cooling without disruption of the surface from exit of the strip from the nip of the casting rolls until the strip surface is cooled to below 150° C., or until the strip is coiled, whichever occurs first, to form a cast steel strip with a protective layer having the appearance and properties described below.

The protective layer may have the appearance of specular hematite formed by cooling in such an oxygen depleted atmosphere without disruption of the layer, as may occur on passing the strip through presently known and commercially used hot rolling mill during cooling. It is believed that the work surfaces of the work rolls of such a hot rolling mill disrupts the protective coating before the layer stabilizes with cooling of the strip. The oxygen content of the atmosphere enclosing the steel strip during cooling may be below 1% or may be below 0.5%.

A steel strip with protective layer of this particular appearance and properties has never been produced before to our knowledge. Specular hematite has been encountered in mineral deposits, but has rarely if ever been artificially produced. The protective layer produced on the novel cast strip of the present invention may or may not be specular hematite, but the layer has the appearance of specular hematite when compared with a mineral deposit. The properties of the protective layer have been difficult to characterize despite extensive analyses. The protective layer has been found to be less than about 100 nanometers (microns) in thickness and typically about 60 to about 80 nanometers in thickness. The protective layer has been found to be predominantly Fe₂0₃ adjacent the base steel, in either a crystalline, amorphous, or mixed crystalline and amorphous form, and very different in appearance from scale formation observed on thin cast steel strip.

Although yet to be confirmed, the theory of the formation of the protective layer is that hematite (Fe₂0₃) is formed adjacent the base steel of the strip during the high temperatures encountered in thin strip casting greater than about 1300° C. at the nip in thin strip casting, and that that structure of the protective layer is maintained in an enclosed atmosphere that has less than about 5% oxygen until the strip is cooled to below about 150° C., without disruption of the layer while cooling. See, D. T. Blazevic, Descaling, presented at Association for Iron & Steel Technology Training Seminar (May 4, 2004), Graph 2, showing 100% hematite (Fe₂0₃) formed on based steel at temperatures above about 1300° C. However, if the strip is coiled before being cooled to 150° C., the enclosing atmosphere can be removed since the strip is tightly wrapped and no longer exposed to an atmosphere having greater than 5% oxygen.

### BRIEF DESCRIPTION OF THE DRAWINGS

The operation of an illustrative twin roll installation in accordance with the present invention will now be described with reference to the accompanying drawings in which:

FIG. 1 is a schematic of a thin cast plant illustrating the present invention;

FIG. 2 is a vertical cross-section through an illustrative twin roll strip caster installation in the plant of FIG. 1;

FIG. 3 is a partial cross-sectional view of a thin cast strip showing the protective layer of the present invention;

FIG. 4 is photography of a sample of the thin cast strip showing the protective layer of the present invention;

FIG. 5 is photography of the opposite side of thin cast strip of FIG. 4 without the protective layer for comparison; and

FIG. 6 is a graph showing an AES depth profile analysis of the protective layer of a sample of the thin cast strip of the present invention.

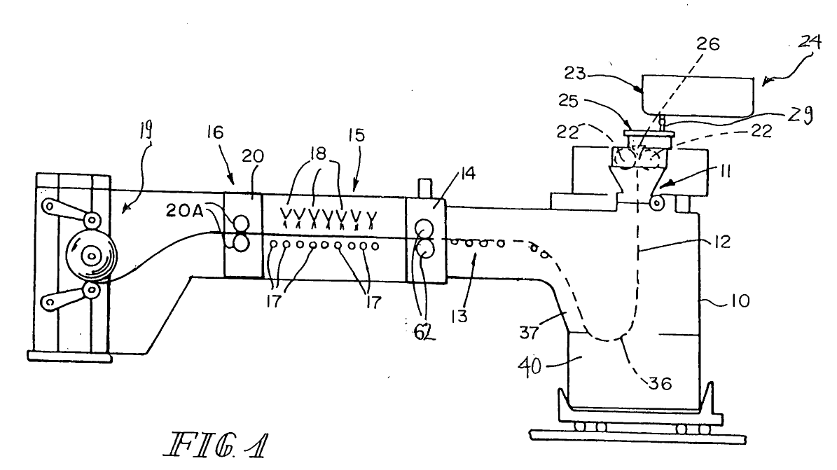

### DETAILED DESCRIPTION OF THE DRAWINGS

The illustrative twin roll caster comprises a twin roll caster denoted generally as 11 producing a cast steel strip 12 which passes within a sealed enclosure 10 to a guide table 13, which guides the strip to a pinch roll stand 14 through which it exits the sealed enclosure 10. The seal of the enclosure 10 provides for a control of the atmosphere within the enclosure of not more than 5% oxygen surrounding the cast strip within the enclosure during cooling. After exiting the sealed enclosure 10, the strip passes through other sealed enclosures 15 and 16 with atmospheres within each enclosure of not more than 5% oxygen surrounding the cast strip while the strip cools to below about 150° C. and may be below about 100° C. Note that the strip 12 is cooled to below about 150° C. in an atmosphere of no more than about 5% oxygen either in the enclosure 15 and 16 before the strip reaches coiler 19, or after the strip is tightly coiled on the coiler 19.

Twin roll caster 11 comprises a pair of laterally positioned casting rolls 22 forming a nip therebetween, to which molten metal from a ladle 23 is delivered through a metal delivery system 24. Metal delivery system 24 comprises a tundish 25 and one or more metal delivery nozzles 21 which are located above the nip. The molten metal delivered to the casting rolls is supported in a casting pool 26 on the casting surfaces of the casting rolls 22 above the nip.

The casting pool of molten steel supported on the casting rolls is confined at the ends of the casting rolls 22 by a pair of first side dams 28, biased against stepped ends of the casting rolls 22 by operation of a pair of hydraulic cylinder units (not shown) acting through thrust rods (not shown) connected to side plate holders (not shown).

The casting rolls 22 are internally water cooled by a coolant supply (not shown) and driven in counter rotational direction by drives (not shown). Heat is thus extracted from the molten metal in the casting pool 26 through the casting roll surfaces of the casting rolls 22, causing metal shells to solidify on the moving casting roll surfaces as the casting surfaces move through the casting pool 26 toward the nip. These metal shells are brought together at the nip to form the thin cast strip 12, which is delivered downwardly from the nip within enclosure 10 in an oxygen depleted atmosphere as above described.

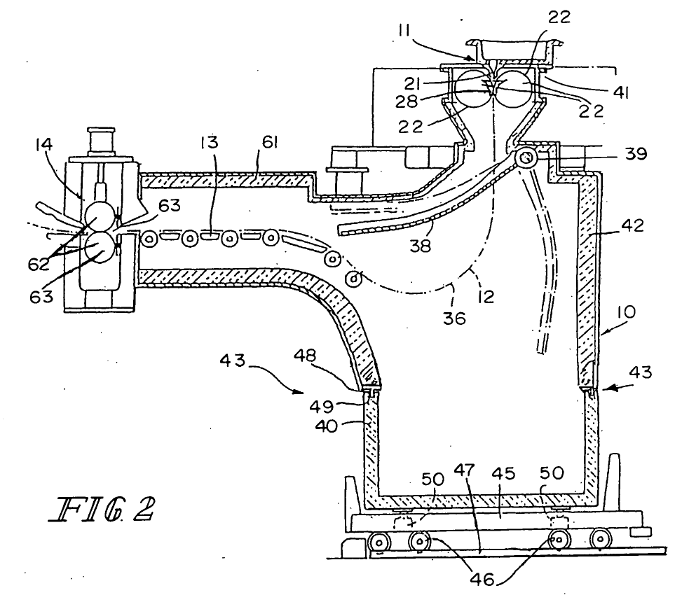

Molten steel is introduced into the tundish 25 from ladle 23 via an outlet nozzle 29. The molten metal flows from the tundish 25 into the casting pool 26. At the start of a casting operation, a short length of imperfect strip may be produced initially as the casting conditions are stabilized. After continuous casting is established, the casting rolls are moved apart slightly and then brought together again to cause this leading end of the strip to break away so as to form a clean head end of the following cast strip to start the casting campaign. The imperfect material drops into a scrap box receptacle 40 located beneath caster 11 and forming part of the enclosure 10 as described below. At this time, swinging apron 38, which normally hangs downwardly from a pivot 39 to one side in enclosure 10, is swung across the strip outlet from the nip to guide the head end of the cast strip onto guide table 13, which feeds the strip to the pinch roll stand 14. Apron 38 is then retracted back to its hanging position to allow the strip to hang in a loop 36 beneath the caster, as shown in FIG. 2, before the strip passes to the guide table 13 where it engages a succession of guide rollers.

The twin roll caster illustratively may be of the kind which is illustrated in some detail in U.S. Pat. Nos. 5,184,668 and 5,277,243, and reference may be made to those patents for appropriate constructional details which form no part of the present invention.

Enclosure 10 is formed by a number of separate wall sections which fit together at various seal connections to form a continuous enclosure wall. These comprise a first wall section 41 which is formed at twin roll caster 11 to enclose casting rolls 22, and a wall enclosure 42 which extends downwardly beneath first wall section 41, to form an opening which is closed by sealing engagement with the upper edges of a scrap box receptacle 40 as described below.

A seal 43 between the scrap box receptacle 40 and the enclosure wall 42 may be formed by a knife and sand seal around the opening in the enclosure wall 42, which can be established and broken by vertical movement of scrap box receptacle 40 relative to the enclosure wall 42. More particularly, the upper edge of the scrap box receptacle may be formed with an upwardly facing channel 49 which is filled with sand and which receives a knife flange 48 depending downwardly around the opening on the enclosure wall 42. A seal is formed by raising the scrap box receptacle to cause the knife flange to penetrate the sand in the channel to establish the seal 43 This seal can be broken by lowering the scrap box receptacle 40 from its operative position preparatory to movement away from the caster to a scrap discharge position (not shown).

Scrap box receptacle 40 is mounted on a carriage 45 fitted with wheels 46, which run on rails 47, whereby the scrap box receptacle can be moved to the scrap discharge position. Carriage 45 is fitted with a set of powered screw jacks 50 operable to lift the scrap box receptacle 40 from a lowered position, in which it is spaced from the enclosure wall 42, to a raised position where the knife flange penetrates the sand to form seal 43 between the two.

Sealed enclosure 10 further may have a third wall section 61 disposed about guide table 13. The third wall section 61 is also connected to the frame of pinch roll stand 14, which includes a pair of pinch rolls 62, against which the enclosure 10 is sealed by sliding seals 63. Enclosure 15 may be similarly sealed. The strip 12 proceeds over cooling table 17 where it is cooled by, for example, cooling jets 18, as it proceeds through pinch rolls 20A in pinch roll stand 20. From the pinch roll stand 20, the strip proceeds to coiler.

Most of the enclosure wall sections 41 and 61, together with wall enclosure 42, may be lined with fire brick. Scrap box receptacle 40 may be lined either with fire brick or with a castable refractory lining.

In this way, the complete enclosure 10 is sealed prior to a casting operation, thereby limiting the access of oxygen to the strip 12 as it passes from casting rolls 22 to the pinch roll stand 14. Initially the strip may take up all of the oxygen from enclosure 10 space to form heavy scale on the strip. However, the sealing of space of enclosure 10 limits the ingress of oxygen-containing atmosphere below the amount of oxygen that could be taken up by the strip. Thus, after an initial start-up period, the oxygen content in the enclosure 10 will remain depleted so limiting the availability of oxygen for oxidation of the strip 12, and the ability to make thin cast strip that can be become strip of the present invention is thereby established.

Of course, a reducing or non-oxidizing gas may be fed into the enclosure 10. In this way, the enclosure can be purged immediately prior to the commencement of casting, so as to reduce the initial oxygen level within the enclosure 10. In this way, the time is reduced that is needed to stabilize the oxygen level as a result of the interaction of oxygen in the sealed enclosure due to oxidation of strip 12 passing through it and the ability to make cast strip of the present invention occurs more rapidly. The enclosure 10 may be conveniently purged with, for example, nitrogen gas to reduce the initial oxygen content in the atmosphere within enclosure 10 to below 5%. For the present invention, the oxygen levels are more desirably below 1% or 0.5%.

The oxygen depleted atmospheres in enclosures 15 and 16 can be established in the same way as described above for the atmosphere in enclosure 10. In this way, the surface of the strip 12 where the protective layer is formed is maintained in the oxygen depleted atmosphere until the strip is cooled to below about 150° C., and may be below about 100° C. Note that cooling to those temperatures may be while the strip 12 is coiled, where the surface of the coiled strip adjacent the protective layer is necessarily exposed to an oxygen depleted atmosphere as above described. Thus, the strip is maintained in the oxygen depleted atmospheres in enclosures 10, 15 and 16 until coiled, which may be generally a temperature between about 400 and about 600° C., or higher.

Also, the cooling in the oxygen depleted atmosphere is done so as not to disturb the surface of the strip 12 adjacent the protective layer during cooling. Thus, the strip is not subjected to a hot rolling mill, unless some special equipment or conditions can be provided to roll the strip without disruption of the surface adjacent the protective layer during cooling. Further, the pinch rolls 62 and 20A used to provide tension on the strip during casting are conditioned so as not to disturb the surface of the cast strip 12 adjacent the protective layer.

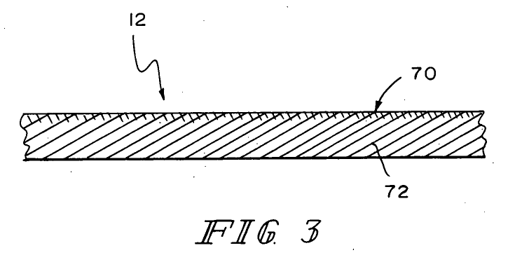

Using the above described twin roll caster, a thin cast strip 12 with a protective layer was made in accordance with the present invention as shown in FIG. 3. The thin cast strip of about 1.8 mm in thickness was at a temperature above about 1300° C. at the nip between the casting rolls 22, and was cooled from that temperature above about 1300° C. to below about 150° C., while being enclosed in a control atmosphere where the oxygen content was below about 5% and without disrupting the surface of the strip e.g., by hot rolling the strip with a conventional hot mill.

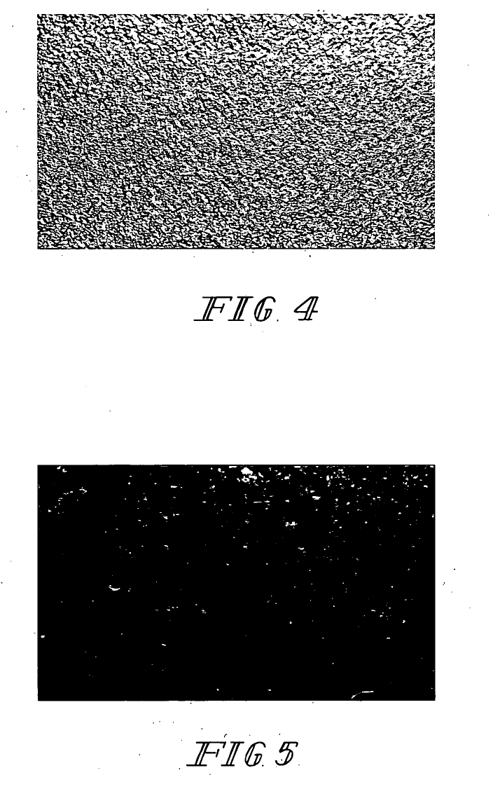

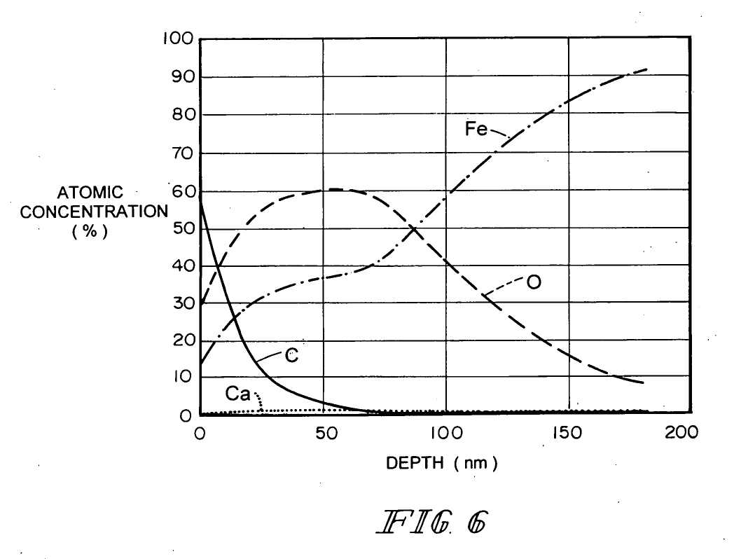

The cross-section of the strip 12 with the protective layer 70 adjacent the base metal 72 is shown in FIG. 3. The surface of the protective layer of the strip 12 with the protective layer is shown in FIG. 4. The opposite side of the strip, which is shown in FIG. 5, exhibits the reddish scale usually observed on thin cast strip exposed to ambient atmospheres with high levels of oxygen at temperatures of about 600 to about 900° C. The strip was not subject to either conventional hot rolling or cold rolling, or otherwise processed while the cast strip 12 was cooled to below about 150° C. However, as described above, the cast strip 12 can be coiled at an appropriate point in the cooling process to maintain the control oxygen-depleted atmosphere to which the protective layer of the strip is exposed by coiling.

The resulting thin cast strip with the protective layer was stable at atmospheric conditions. The protective layer showed no observable signs of rust or other change of color or texture after several days and weeks. The surface of the protective layer had the appearance of mineral samples of specular hematite (also known as specularite). To characterize the protective layer, a sample of the thin cast strip with the protective layer was subjected to AES depth analysis. The results are shown in FIG. 6. The depth of the protective layer was found to approximate about 60 nanometers in thickness. The ratio of O to Fe in the analysis evidences the formation of Fe₂0₃ adjacent the base metal of the thin cast strip. This differed from the usual scale formation of thin cast strip where FeO is usually formed adjacent the base steel of the strip.

The sample could not be subjected to chemical analysis because the thickness of the protective layer was so thin namely, less than about 100 nanometers and generally less than about 60 nanometers. Nor could it be determined whether the protective layer was crystalline or amorphous. However, the analysis of the protective layer is consistent with a mixture of crystalline and amorphous form of Fe₂0₃ adjacent the base metal of the strip 12.

Samples were also subjected to reflectivity analysis where the reflectivity of the protective layer was compared with the reflectivity of the opposite side of the sample. The reflectivity of the protective layer was found to be about 40% to about 50% of the light in the 400 to 700 nanometer wavelength. This compared to a reflectivity of about 30% to about 40% of the light in the 400 to 700 nanometer wavelength for normal thin cast strip as seen on the back of the sample.

Although the invention has been illustrated and described in detail in the foregoing drawings and description with reference to several embodiments, it should be understood that the description is illustrative and not restrictive in character, and that the invention is not limited to the disclosed embodiments. Rather, the present invention covers all variations, modifications and equivalent structures that come within the scope and spirit of the invention. Additional features of the invention will become apparent to those skilled in the art upon consideration of the detailed description, which exemplifies the best mode of carrying out the invention as presently perceived. Many modifications may be made to the present invention as described above without departing from the spirit and scope of the invention.

What is claimed is:

1. A steel strip made by thin-strip casting having a protective layer of less than about 100 nanometers with Fe₂0₃ adjacent the base metal of the strip.

2. The thin cast steel strip of claim 1 wherein the protective layer is between about 60 and about 80 nanometers.

3. The thin cast steel strip of claim 1 wherein at least a portion of the layer is in amorphous form.

4. The thin cast steel strip of claim 1 wherein at least a portion of the layer is in crystalline form.

5. The thin cast steel strip of claim 1 wherein at least a portion of the layer is a mixture of crystalline and amorphous forms.

6. A steel strip made by thin-strip casting having thereon a protective layer having a surface appearance of specular hematite.

7. A steel strip with a protective layer of less than about 100 nanometers made by steps comprising the following:
assembling a pair of casting rolls in lateral relationship to form a nip between them through which metal strip may be cast;
forming a casting pool of molten metal supported on the casting rolls above the nip at a temperature such that the temperature of the steel at the nip between the casting rolls is greater than about 1300° C.;
counter-rotating the casting rolls such that the peripheral surfaces of the casting rolls each travel toward the nip to produce a cast strip downwardly from the nip;
passing the continuously cast strip through at least one cooling chamber that has less than about 5% oxygen to cool the strip to less than about 150° C., without disruption of the surface of the strip where the protective layer is desired, to form on the surface of the strip a protective layer less than 100 nanometers in thickness having Fe₂0₃ adjacent the base metal of the strip.

8. The thin cast steel strip with a protective layer of less than about 100 nanometers as claimed in claim 7 wherein the oxygen content in the cooling chamber(s) is less than about 1%.

9. The thin cast steel strip with a protective layer of less than about 100 nanometers as claimed in claim 7 wherein the oxygen content in the cooling chamber or chambers is less than about 0.5%.

10. The thin cast steel strip with a protective layer of less than about 100 nanometers as claimed in claim 7 wherein the strip is cooled to less than about 100° C.

11. A thin cast steel strip made by thin strip casting, the steel strip having a protective layer with Fe₂0₃ adjacent the base metal of the strip and that reflects more than about 40% of white light radiation in 400 to 700 nanometer wavelength range.

12. The thin cast steel strip as claimed in claim 11 wherein the protective layer reflects between 40 and 50% of the white light radiation in the 400 to 700 nanometer wavelength.

13. A method of producing thin cast strip with a protective layer comprised of the following steps:
a) assembling a pair of casting rolls having a nip therebetween;
b) assembling a metal delivery system capable of delivering molten metal to form a casting pool between the casting rolls above the nip, and first side dams adjacent the ends of the nip to confine said casting pool;
c) introducing molten steel to form a casting pool supported on casting surfaces of the casting rolls confined by said first side dams at a temperature such that the temperature of the steel at the nip between the casting rolls is above about 1300° C.;
d) counter-rotating the casting rolls to form solidified metal shells on the surfaces of the casting rolls and cast thin steel strip through the nip between the casting rolls from said solidified shells;
e) enclosing the thin cast strip in an atmosphere of less than 5% oxygen during cooling without disruption of the strip surface from the emergence of the strip from the nip of the casting rolls until the strip is cooled to below 150° C. or until the strip is coiled, whichever occurs first, to form a cast steel strip with a protective layer having the appearance of specular hematite.

14. The thin cast steel strip with a protective layer of less than about 100 nanometers as claimed in claim 13 having Fe₂0₃ present adjacent the base metal of the strip and wherein the oxygen content in the cooling chamber(s) is less than about 1%.

15. The thin cast steel strip with a protective layer of less than about 100 nanometers as claimed in claim 13 having Fe₂0₃ present adjacent the base metal of the strip and wherein the oxygen content in the cooling chamber or chambers is less than about 0.5%.

16. The thin cast steel strip with a protective layer of less than about 100 nanometers as claimed in claim 13 having Fe₂0₃ present adjacent the base metal of the strip and wherein the strip is cooled to less than about 100° C.

17. A thin cast steel strip made by thin strip casting having a protective layer having Fe₂0₃ present and having a surface appearance similar to that shown in FIG. 4.

18. The thin cast steel strip as claimed in claim 17 having a protective layer having Fe₂0₃ present adjacent the base metal of the strip, where the protective layer has a thickness less than about 100 nanometers.
